(19) United States
(12) Patent Application Publication
(10) Pub. No.: US 2005/0213580 A1
(43) Pub. Date: Sep. 29, 2005

(54) System and method for enforcing policies directed to session-mode messaging

(76) Inventors: Georg Mayer, Helsinki (FI); Aki Niemi, Helsinki (FI); Simo Veikkolainen, .Espoo (FI); Teemu Jalava, Espoo (FI)

Correspondence Address: CRAWFORD MAUNU PLLC, 1270 NORTHLAND DRIVE, SUITE 390, ST. PAUL, MN, 55120, US

(21) Appl. No.: 10/808,200

(22) Filed: Mar. 24, 2004

(51) Int. Cl. H04L 12/56

(52) U.S. Cl. 370/395.2

(57) ABSTRACT

A system and method for enforcing policies for session-mode messaging between two or more communication devices. A policy is imposed by a signaling-level session control element on a communication device to establish a bearer-level binding between the communication device and bearer-level relay. A state of the bearer-level binding is determined, which is provided to the signaling-level session control element. The signaling-level session control element allows or disallows the first communication device to engage in the session-mode messaging based on the state of the bearer-level binding.

### FIELD OF THE INVENTION

This invention relates in general to messaging communications, and more particularly to a system and method for enforcing signaling-level policies pertaining to session-mode messaging between communication devices.

### BACKGROUND OF THE INVENTION

Advances in communication infrastructures and protocols have allowed standard computing devices to become valuable communication tools. Computers communicate with each other, and with other electronic devices, over networks ranging from local area networks (LANs) to wide reaching global area networks (GANs) such as the Internet. Other electronic devices have experienced similar transformations, such as mobile phones, personal digital assistants (PDAs), and the like. Today, these wireless devices are being used for a variety of different types of communication. For example, while the analog mobile phone was traditionally used for analog voice communications, the present-day mobile phone is a powerful communication tool capable of communicating voice, data, images, video, and other multimedia content. With the integration of wireless and landline network infrastructures, information of all types can be conveniently communicated between wireless and landline devices.

Network architectures exist that facilitate real-time services in operator networks for such devices. For example, the 3rd Generation Partnership Project (3GPP) IP Multimedia core network Subsystem (IMS) is an architecture for supporting multimedia services via a Session Initiation Protocol (SIP) infrastructure. The IMS interacts both with the Public Switched Telephone Network (PSTN) and the Internet (or other such large-scale network) to provide various multimedia services to users. In IMS environments, proxies are identified as Call Session Control Functions (CSCF), of which various types exist, including a proxy CSCF (P-CSCF), a serving CSCF (S-CSCF), and interrogating CSCF (I-CSCF). Generally, an S-CSCF performs and/or assists in performing a number of functions, including controlling session management functions for the IMS, providing access to home network servers such as location services, authentication, etc. A P-CSCF generally serves as the point of contact for applications (such as the mobile device client applications), and performs and/or assists in performing functions such as translation, security, authorization, etc. An I-CSCF generally serves as a point of contact in the home network for connections destined to a subscriber of that home network or roaming subscribers currently located within that network's service area. It may perform a number of functions, such as assigning an S-CSCF to a user performing registration, contacting the Home Subscriber Server (HSS) to obtain the S-CSCF address, forwarding SIP requests/responses to the S-CSCF, etc.

The 3GPP IMS utilizes SIP in order to achieve a wide range of functionality with the network. SIP, defined by the Internet Engineering Task Force (IETF) (e.g., RFC 3261; June 2002) is an end-to-end signaling protocol that facilitates (among other things) the establishment, handling and release of end-to-end multimedia sessions. It can be used in applications such as Internet conferencing, telephony, presence, events notification, instant messaging, and the like. SIP enables network endpoints to discover one another and to agree on a session characterization. In order to locate other users, SIP utilizes an infrastructure of network proxy servers such as the aforementioned CSCFs to which users can send registrations, invitations to sessions, and other requests via their devices. SIP supports various aspects of establishing and terminating sessions, such as user availability, session setup such as ringing, session management, and some limited terminal capabilities.

SIP enables a user to make voice-based, video-based, or other media-based calls, commonly referred to as “sessions.” A “session” generally refers to a logical connection between computers or other devices and the communications exchanged between those devices while they are connected. In addition, SIP enables the communication of messages between two or more users. These messages may include text, or media types such as text, audio, video, images, etc. For such “messaging,” SIP differentiates between page-mode messaging and session-mode messaging. For example, page-mode messaging involves messages, such as Instant Messages (IM), to be transported via the signaling plane. Such messages may be sent using, for example, the SIP MESSAGE method, and these messages are independent of each other and have no formal relationship therebetween. Thus, each such page-mode message involves a complete SIP transaction, including a request and a response. Page-mode messaging is convenient for communicating small numbers of messages, but has limitations. For example, messages cannot be overlapped, in that an acknowledgment must be received before sending another message. Further, because each message involves a complete SIP transaction, the overhead can become an issue where more than a relatively small number of messages are being communicated.

Session-mode messaging, on the other hand, involves establishing the session via the signaling layer, and allowing the actual messages (bearer) to be sent in a different way. A chat session is an example of session-mode messaging. One manner in which session-mode messaging may be effected is by way of the Message Session Relay Protocol (MSRP), which is a protocol for transmitting a series of instant messages within a session. Session-mode messaging may be beneficial in situations where it is useful for instant messages to be formally associated in a session, such as where a user would like to join a text conference, participate in the conference, and then leave the conference. Additionally, messaging overlap is allowed, and where more than a small number of messages are to be communicated, establishing a messaging session can reduce signaling overhead.

With page-mode messaging intervening SIP proxies such as the P-CSCFs and S-CSCFs are involved in each message transfer, as the messages are sent through the signaling channel. While this presents potentially undesirable messaging load on such proxies, there are advantages to having such intermediaries involved with each message transfer. For example, messages can be tracked for logging purposes, and charging for message transfers (e.g., per-message cost) can be readily accomplished.

On the other hand, session-mode messaging uses the signaling channel and associated proxies to set up the messaging session, but the messages are sent via another path, generally referred to herein as the bearer level. In some cases, this allows the actual messages to be sent directly between the communicating devices without any intervening intermediary that can effect functions such as charging, logging, etc. It may be important, however, to be able to track the messages for such charging, logging or other purposes. More particularly, in a two-way (or more) messaging session, the messaging media may be exchanged directly between the users without the involvement of IMS network elements. For some purposes such as charging and logging, it may be desirable for an operator to use an intermediary through which the messages are sent. For example, per-message charging within a messaging session would be possible in IMS.

In order to track such messages, a network may require a user to include an intermediary in the path of the bearer-level messages. However, there is currently no way to enforce such a policy, as the bearer has no accountability to the signaling plane that would enforce the policy. Therefore, even if a network required users to include an intermediary in the path of the message session, the user could disregard the request and route the messages directly to the other communicating device(s). The network, however, must be able to enforce such policies if logging, charging, or other functions are necessary or otherwise desirable.

Accordingly, there is a need for a manner for enforcing signaling plane policies in messaging sessions where the messages do not otherwise traverse the signaling proxies. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system and method for enforcing policies for session-mode messaging between two or more communication devices.

In accordance with one embodiment of the invention, a method is provided for enforcing a signaling-level policy on bearer-level session-mode messaging. The method includes initiating session-mode messaging involving a first communication device and one or more second communication devices. A policy is imposed by a signaling-level session control element on the first communication device to establish a bearer-level binding between the first communication device and bearer-level relay. A state of the bearer-level binding is determined, which is provided to the signaling-level session control element. The signaling-level session control element allows or disallows the first communication device to engage in the session-mode messaging based on the state of the bearer-level binding.

In accordance with another embodiment of the invention, a method is provided for enforcing signaling-level policies directed to bearer-level message sessions. The method includes imposing a policy on a communication device anticipating participation in a message session, where the policy is initiated at a signaling-level element and includes a directive for the communication device to include an intermediary in a path of the message session. It is determined whether the communication device has included the intermediary in the path of the message session. If so, the signaling-level element is notified that the communication device has indeed included the intermediary in the path of the message session. In response, the signaling-level element allows the communication device to participate in the message session.

According to more particular embodiments of such a method, the signaling-level element may prohibit participation by the communication device in the message session if it is determined that the communication device has not included the intermediary in the path of the message session. This determination may involve determining whether the signaling-level element receives the notification within a predetermined time, e.g., before a timeout period expires. In one embodiment, determining whether the communication device has included the intermediary in the path of the message session involves determining whether the intermediary has received a binding message identifying the intermediary from the communication device. The communication device may include the intermediary into the path of the message session by issuing a binding message, such as a Message Session Relay Protocol (MSRP) BIND message, to the intermediary.

According to still other particular embodiments of such a method, the policy may be imposed by a Serving-Call Session Control Function (S-CSCF) within an Internet Protocol (IP) Multimedia Subsystem (IMS). This may involve, for example, sending the policy from the S-CSCF to the communication device via Session Initiation Protocol (SIP) signaling. The message session itself may be conducted using the Message Session Relay Protocol (MSRP), where the intermediary thus serves as an MSRP relay. To include the MSRP relay in the path of the message session, an MSRP BIND message may be sent from the communication device to the MSRP relay.

According to a Go-based solution of such a method, imposing at least one policy that is initiated at the S-CSCF may include the requesting generation of an authorization token from a Policy Decision Function (PDF), transmitting the authorization token to the communication device, and requesting the communication device to send the MSRP BIND message, including the authorization token, to the MSRP relay. In such an embodiment, determining whether the communication device has included the intermediary in the path of the message session may involve sending at least the authorization token from the MSRP relay to the PDF via the Go interface, and determining at the PDF that the communication device is authorized to participate in the message session based on receipt of the authorization token. Further, notifying the signaling-level element may involve the PDF notifying the S-CSCF that the communication device has included the MSRP relay in the path of the message session and is authorized to participate in the message session. This PDF-to-S-CSCF notification may be effected via a Gq interface between the S-CSCF and the PDF.

According to an ISC-based solution of such a method, the MSRP relay may also serve as an Application Server (AS), where the S-CSCF subscribes to an event package at the AS. In such a case, the S-CSCF is notified (e.g., SIP NOTIFY via an ISC interface) by the AS if it is determined that the communication device has included the intermediary in the path of the message session.

In accordance with another embodiment of the invention, a method is provided for enforcing signaling-level policies directed to bearer-level message sessions. The method includes initiating a policy at from the signaling level and imposing the policy on a communication device anticipating involvement in a message session. It is determined at the bearer level whether the communication device has complied with the policy, and if so, a notification is sent from the bearer level to the signaling level indicating that the communication device has complied with the policy. The communication device is allowed to engage in the message session in response to receipt of the policy compliance notification.

In accordance with another embodiment of the invention, a system is provided for enforcing signaling-level policies in an IP Multimedia Subsystem (IMS) network. The system includes a first communication device capable of communicating signaling messages via the IMS network and participating in session-mode messaging via a bearer path. A signaling-level proxy is configured to impose a policy on the first communication device via the IMS network; where the policy requires the first communication device to include the intermediary into the bearer path of the session-mode messaging. An intermediary is configured to relay messages of the session-mode messaging between the communication device and one or more other participating communication devices. The intermediary is further configured to receive at least one binding message from the first communication device, and in response to provide compliance information indicating compliance of the policy by the first communication device. In response, the signaling-level proxy enables the first communication device to participate in the session-mode messaging.

According to more particular embodiments of such a system, the signaling-level proxy represents an S-CSCF, the session-mode messaging is conducted using the MSRP via the bearer path, and the intermediary is an MSRP relay. A Multimedia Resource Function Processor (MRFP) may serve as the MSRP relay. In one embodiment, the first communication device includes a processor configured to generate the binding message as an MSRP BIND message for transmission to the MSRP relay to include the MSRP relay into the bearer path for the session-mode messaging.

According to another particular embodiment of the system, a Policy Decision Function (PDF) may be logically coupled between the MSRP relay and the S-CSCF, where the MSRP relay is configured to forward an authorization token received via the MSRP BIND message to the PDF, and where the PDF is configured to provide the compliance information to the S-CSCF in response to receiving the authorization token. A Go interface may be provided between the MSRP relay and the PDF to communicate authorization token, and a Gq interface may be provided between the PDF and the S-CSCF to communicate the compliance information.

According to another particular embodiment of such a system, the S-CSCF may be configured to subscribe to an event package at the MSRP relay, where the S-CSCF is configured to subscribe to an event package at the MSRP relay for notifications regarding the compliance information. In one embodiment, the MSRP relay also serves as an Application Server (AS), whereby the S-CSCF subscribes to the event package at the AS for notifications regarding the compliance information. In one embodiment, the relay/AS is configured to issue a notification to the subscribing S-CSCF via an ISC interface in response to the MSRP relay receiving the MSRP BIND message. In still a more particular embodiment, the AS may be a SIP AS, where the S-CSCF is configured to subscribe to the event package using a SIP SUBSCRIBE method, and the SIP AS is configured to issue the notification to the subscribing S-CSCF using a SIP NOTIFY method.

In accordance with another embodiment of the invention, a computer-readable medium is provided having instructions stored thereon that are executable by computing systems for enforcing a signaling-level policy on bearer-level session-mode messaging. The executable instructions perform steps including imposing a policy by a signaling-level session control element on at least a first communication device to establish a bearer-level binding between the first communication device and bearer-level relay, determining a state of the bearer-level binding between the first communication device and the bearer-level relay, and allowing or disallowing the first communication device to engage in a message session based on the state of the bearer-level binding.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 is a block diagram illustrating a system for policing messaging sessions in accordance with one embodiment of the present invention;

FIG. 2 is a block diagram illustrating a more particular embodiment of the policy enforcement in accordance with the present invention;

FIG. 3 is a message flow diagram illustrating an exemplary message flow in accordance with the principles of the present invention;

FIGS. 4 and 5 are block diagrams illustrating alternative, representative embodiments for providing signaling-level enforcement of local policies for bearer-level message sessions in accordance with the present invention;

FIG. 6 is a flow diagram illustrating one embodiment of a method for enforcing a signaling-level policy on a message session that does not occur by way of the signaling plane;

FIG. 7 is a flow diagram illustrating another embodiment of a method for enforcing signaling-level policies in accordance with the invention;

FIG. 8 is a flow diagram illustrating one embodiment of a method for enforcing such policies using a Go/Gq interface-based solution in an IMS network environment in accordance with the present invention; and

FIG. 9 is a flow diagram illustrating one embodiment of a method for enforcing such policies using an ISC-based solution in an IMS network environment in accordance with the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

As indicated above, a network may desire or require a user to include an intermediary in the path of the bearer-level messages to enable logging, charging, or other functions to be effected. For example, a network operator may want to charge on a per-message basis for a session-mode chat session. There is currently no way to enforce such a policy, as the bearer has no accountability to the signaling plane that would enforce the policy. Even if a network required users to include an intermediary in the path of the message session, the user could disregard the request and route the messages directly to the other communicating device(s). The present invention addresses these and other problems. It should be noted that the invention is applicable in various environments where signaling plane policies may require enforcement for session-mode messaging. The particular networks and protocols described in connection with the various embodiments below are therefore representative of the types of networks and protocols to which the present invention is applicable, and are not intended to restrict the invention to such particular networks/protocols.

In some network systems or subsystems, it may be necessary or beneficial to introduce message relays at the bearer level that may be used connection with message transport via certain protocols. For example, the Message Session Relay Protocol (MSRP) provides for transmitting a series of instant messages (IM) within a session, where such MSRP sessions are managed using protocols carried by a signaling protocol such as the Session Initiation Protocol (SIP). Protocols such as MSRP may support end-to-end sessions, and/or may support sessions involving message relays at the bearer level. For example, an endpoint may wish to initiate a session at a relay rather than hosting the session directly because network topology or local policy may prevent other devices from connecting to that endpoint. Thus, a User Equipment (UE) may delegate session hosting responsibility to a relay.

For protocols such as MSRP that support the use of relays, there is currently no connection between the proxies at the signaling level and the relays on the bearer level. The user/UE must therefore contact and include any such relays into the path of the messages. Not only does this require a specific action on the part of the user, such a solution also fails to facilitate policy enforcement on the network. As mentioned above, the network may provide indications to users when such relays are to be included into the bearer flow, but the user may simply opt to disregard such policy which may be undesirable for a number of reasons, including logging and charging purposes. In other words, while page-mode message uses signaling proxies where message logging and/or charging can be managed or outsourced, the session-mode messaging of protocols such as MSRP may allow end-to-end messaging without relay involvement at the bearer level. In such cases, charging functions, logging functions, or other desired functions may be subverted if the user does not include such relays into the path of the messages.

Generally, the present invention provides a system and method for enforcing such policies for session-mode messaging between two or more communication devices. A signaling-level policy is imposed on a communication device, such as a requirement that the communication device include an intermediary in the path of the session-mode messaging. Whether the communication device observes such a policy can be determined in accordance with the invention. It is determined whether the communication device has indeed included the intermediary(s) into the path of the messages. Alternatively stated, it is determined whether the device has appropriately “bound” itself to the intermediary(s) for sending and receiving messages through the intermediary(s). This determination results in a state of compliance that is communicated to the signaling plane, where a signaling proxy(s) or other designated network element in the signaling plane will allow the session-mode messaging to take place if it is determined that the communication device has complied with the local policy. If the device has not complied, the signaling plane can prevent or terminate the session-mode messaging with respect to that communication device.

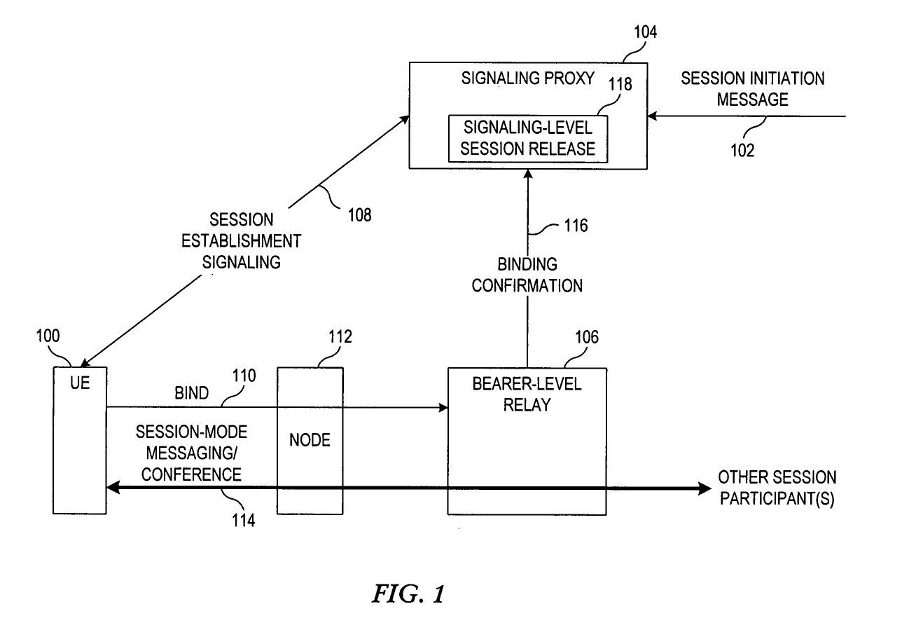

FIG. 1 is a block diagram illustrating a system for policing messaging sessions in accordance with one embodiment of the present invention. In the illustrated embodiment, the User Equipment (UE) 100 represents one of the parties to a messaging session. The UE 100 may represent any communication device, including but not limited to a mobile phone, Personal Digital Assistant (PDA), portable or desktop computing device, or the like. In the illustrated example, it is assumed that UE 100 is a proposed party to which an initiating UE (not shown) seeks to establish a messaging session. To establish the messaging session, a signaling protocol is used such as the Session Initiation Protocol (SIP). While any signaling protocol may be used to properly establish the session, much of the description provided herein is described in terms of SIP for the signaling protocol.

The initiating UE sends a session establishment request including a session initiation message, such as a SIP INVITE request, to its respective signaling proxy (not shown). The session initiation message 102 (e.g., INVITE) is forwarded to a signaling proxy 104 associated with the targeted UE 100. The signaling proxy 104 may represent, for example, a Serving-Call Session Control Function (S-CSCF) in the IP Multimedia Subsystem (IMS). However, due to a local policy or other requirement that may be enforced at the signaling proxy 104, the signaling proxy 104 may not allow the UE 100 to engage in the session without the involvement of an intermediary, such as the bearer-level relay 106. To ensure user compliance with the local policy, the present invention provides a manner of securing local policy compliance before allowing the UE 100 to engage in the session, as described more fully below. It should be noted that while the description associated with FIG. 1 illustrates a single party (UE 100) to the messaging session, other UEs involved in the messaging session may require analogous policy enforcement.

When the signaling proxy 104 receives the session initiation message 102, it forwards the message towards the UE 100, as indicated by the session establishment signaling 108. This signaling 108 may include the session initiation message 102, as well as appropriate signaling response codes. For example, upon receiving a SIP INVITE request, the UE 100 may respond with a SIP response code “183” which indicates “session progress.” In one embodiment, this state may be held until the signaling proxy 104 has been assured that the UE 100 has included the relay 106 in the message path. It should be noted that the session establishment signaling 108 may occur through other signaling proxies, such as a Proxy-CSCF (P-CSCF) that serves as the first point of contact for the UE 100 to the signaling network. More particular embodiments involving IMS elements such as the P-CSCF and S-CSCF are described more fully below.

The UE 100 receives the INVITE or other session initiation message 102, and ultimately constructs a binding request (BIND) 110 with an address referring to the bearer-level relay 106. The UE 100 may include a processor (not shown) or other appropriate logic to generate the BIND request 110. The BIND request 110 is transmitted to the relay 106, using communication logic such as a transceiver, via the appropriate network nodes 112 such as a Gateway GPRS Support Node (GGSN) used to bridge IMS and General Packet Radio Service (GPRS) networks. If the relay 106 responds with a success message (e.g., 200 OK), the UE 100 can use the relay address as the session address. Thus, the UE 100 has properly bound itself to the relay 106, which may be required by local policy.

In accordance with the invention, the relay 106 directly or indirectly communicates to the signaling proxy 104 a binding confirmation 116 to confirm that the UE 100 has included the relay 106 in the session 114 as mandated by local policy. As described more fully below, the present invention contemplates multiple embodiments for communicating such a binding confirmation 116. The signaling proxy 104 controls the session on the signaling level, based on whether such a binding confirmation 116 has been received at the signaling proxy 104. For example, if a binding confirmation 116 is received by the signaling proxy indicating proper UE 100 binding to the relay 106, the signaling proxy 104 permits the UE 100 to engage in the session 114 with another participant(s) to the session/conference.

On the other hand, if such a proper binding confirmation 116 is not received, the signaling proxy 104 can release the session on the signaling level. In one embodiment of the invention, the signaling proxy 104 may delay forwarding of any UE 100 message that the request was successful (e.g., 200 OK) to the initiating UE, unless and until the signaling proxy 104 has received the binding confirmation 116. For example, if the signaling proxy 104 does not receive the binding confirmation 116 within a predetermined time (e.g., timeout value) or before a particular event occurs, the signaling proxy 104 may prohibit the session. In another embodiment, the session may initially be allowed, but failure of receipt of the binding confirmation 116 causes any session 114 to be released by the signaling proxy 104, such as by initiating a SIP BYE request upon expiration of a predetermined time duration. In any event, the signaling proxy 104 releases the session via a signaling-level session release 118 module associated with or otherwise accessible to the signaling proxy 104.

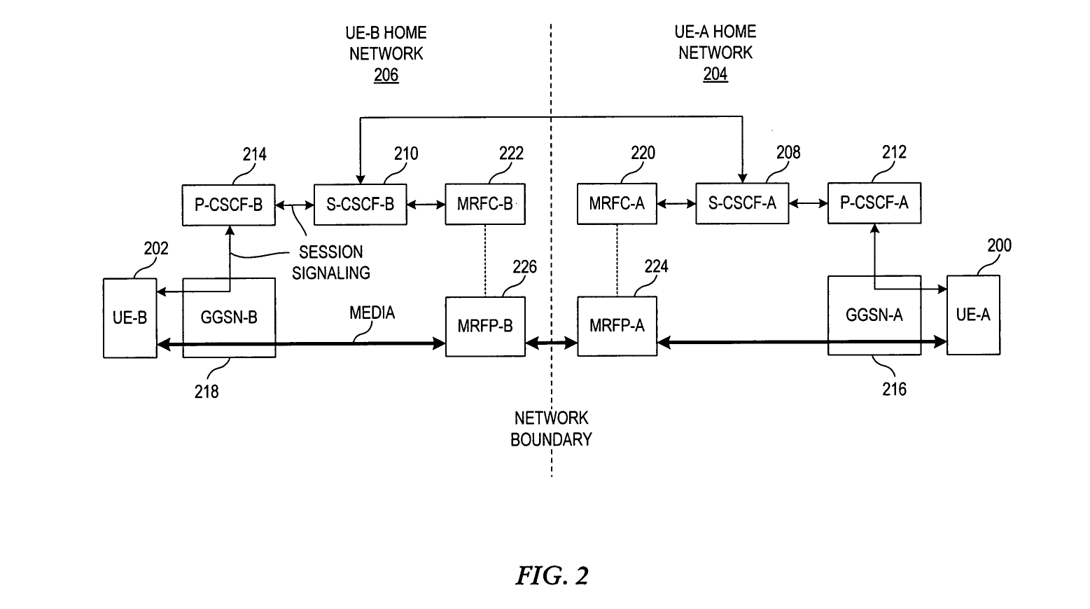

FIG. 2 is a block diagram illustrating a more particular embodiment of the policy enforcement in accordance with the present invention. For purposes of example, the embodiment of FIG. 2 is described in terms of General Packet Radio Service (GPRS) networks and the IP Multimedia Subsystem (IMS). Thus, GSM/GPRS and IMS are used as representative network architectures in which the principles of the present invention may be employed. However, as will be readily apparent to those skilled in the art from the description provided herein, the present invention is applicable in other current or future network environments.

To facilitate an understanding of the embodiment illustrated in FIG. 2, a brief description is provided of the GPRS and IMS network environments. GPRS is a packet-switched wireless communication standard for Global System for Mobile Communications (GSM) that mirrors the Internet model and enables seamless transition towards 3G networks. GPRS provides actual packet radio access for mobile GSM and time-division multiple access (TDMA) users. With respect to IMS, the Third Generation Partnership Project (3GPP) has standardized the Universal Mobile Telecommunications System (UMTS) in various phases, where Release 5 included a system where the packet-switched core network (PS-CN) dominates over circuit-switched, and further took responsibility of telephony services. Release 5 introduced a new core network into the UMTS architecture, namely the IP Multimedia Subsystem (IMS) core that supports both telephony and multimedia services.

The IMS interacts both with the Public Switched Telephone Network (PSTN) and the Internet (or other data network) to provide various multimedia services to users. Signaling in IMS is generally performed using SIP, and FIG. 2 is described in generic terms of a SIP-enabled network (or analogous protocol), which sets forth network elements such as proxy servers, registrars, and the like. In IMS, these generic network elements are more particularly named and defined, and the present invention is equally applicable to IMS-based communication. For example, a SIP proxy is identified as a Call State Control Function (CSCF), of which various types exist, including a Proxy CSCF (P-CSCF), a Serving CSCF (S-CSCF), and an Interrogating CSCF (I-CSCF). Generally, an S-CSCF performs and/or assists in performing a number of functions, including controlling session management functions for the IMS, providing access to home network servers such as location services, authentication, etc. A P-CSCF generally serves as the point of contact for applications (such as mobile device client applications), and performs and/or assists in performing functions such as translation, security, authorization, etc. An I-CSCF generally serves as a point of contact in the home network for connections destined to a subscriber of that home network or roaming subscribers currently located within that network's service area. It may perform a number of functions, such as assigning an S-CSCF to a user performing registration, contacting the Home Subscriber Server (HSS) to obtain the S-CSCF address, forwarding SIP requests/responses to the S-CSCF, etc.

Referring now to FIG. 2, one embodiment of the present invention is described in connection with an IMS environment. In this example the users, UE-A 200 and UE-B 202, are located in different networks 204, 206. According to standard IMS procedures, both UEs 200, 202 are assigned and have registered to a respective S-CSCF-A 208 and S-CSCF-B 210, which perform session control for their respective UEs. The P-CSCF-A 212 and P-CSCF-B 214 serve as entry points for their respective UEs 200, 202 to the IMS domain. In the illustrated embodiment, access to the IMS domain by the UEs 200, 202 is provided via the respective GGSN-A 216, GGSN-B 218 and the underlying packet-switched core network.

For conferencing purposes, the networks may also deploy Multimedia Resource Function Controllers (MRFC-A 220, MRFC-B 222) that act as centralized signaling nodes for conferences. The media manipulation and mixing for conference services is provided by the Multimedia Resource Function Processors (MRFP) 224, 226, which are controlled by the respective MRFC 220, 222 using a control protocol. As can be seen, the MRFCs 220, 222 are in the session signaling path, while the MRFPs 224, 226 are in the media path.

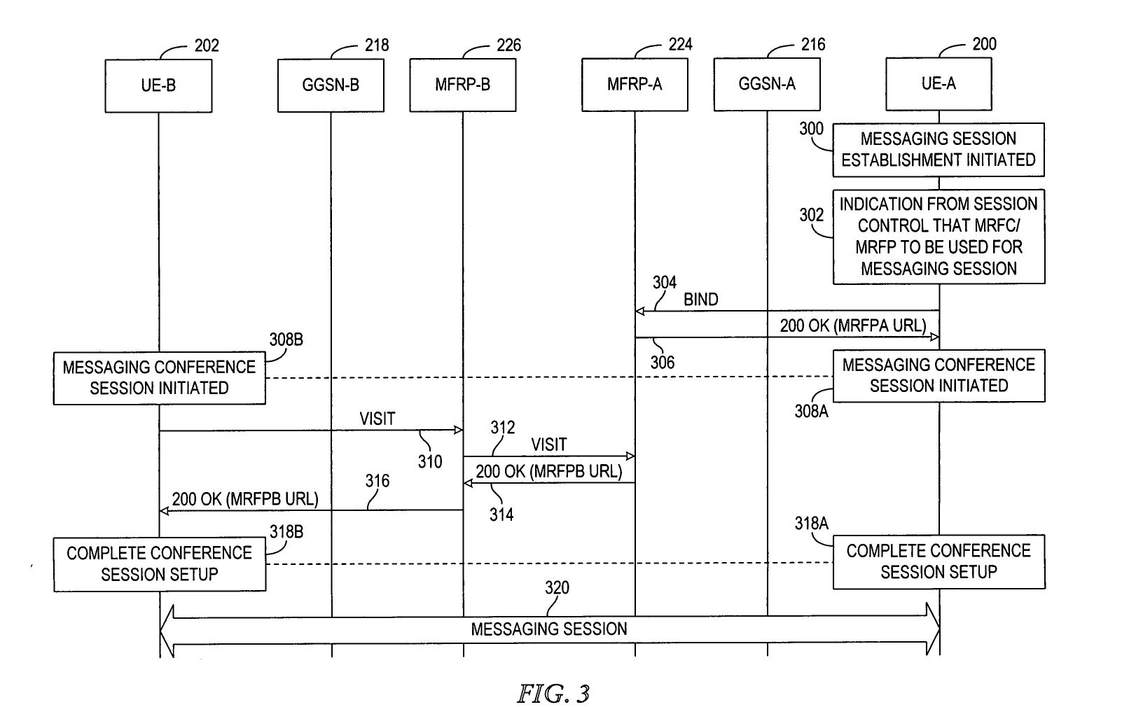

FIG. 3 is a message flow diagram illustrating an exemplary message flow in accordance with the principles of the present invention. The example described below is described in connection with FIGS. 2 and 3, and like reference numbers are used where appropriate. The example of FIGS. 2 and 3 is further described in terms of conferencing and messaging services based on the Message Session Relay Protocol (MSRP), which is a protocol that facilitates the transmission of a series of instant messages (IM) within a session, where such MSRP sessions are managed using protocols carried by a signaling protocol such as SIP. As previously indicated, MSRP currently provides for user control of whether an intermediary is used or needed in a messaging session. The present invention enhances such a messaging session environment by allowing the network to introduce an intermediary to the messaging media path which can be hidden from the end user, while enforcing policies requiring the inclusion of the intermediary(s) in the media path.

Referring to FIGS. 2 and 3, a representative example involves UE-A 200 wishing to establish a messaging session with UE-B 202. UE-A 200 sends a session establishment request to its S-CSCF-A 208 by way of P-CSCF-A 212, indicating in a session initiation message that the media type is messaging media MSRP. The session initiation message may be, for example, a SIP INVITE request where the media type “MSRP” is provided in the body of the SIP INVITE request. Establishing of the messaging session establishment in this manner is illustrated at block 300.

Due to a local policy, the S-CSCF-A 208 does not allow the creation of a messaging session without an intermediary. Therefore, the S-CSCF-A 208 indicates 302 that the messaging session deploying MRFC-A 220 and MRFP-A 224 should be created. The S-CSCF 208 may notify the UE-A 200 that such an intermediary is required by sending any appropriate SIP message to the UE-A 200 via its respective P-CSCF 212. For example, this may be indicated in a response message to the SIP INVITE message. In response, UE-A 200 now reserves resources from MRFP-A 224. More particularly, UE-A 200 may perform an MSRP “BIND” operation to MRFP-A 224, as depicted via message path 304. The address of MRFP-A 224 may be provided to UE-A 200 by the network (e.g., S-CSCF-A 208), or the address may be configured at UE-A 200 itself. If successful, the MRFP-A 224 responds with an acknowledgement indicating success, such as a ”200 OK” message 306. Included in the message information of such a response 306 is information regarding the reserved resource MRFP-A 224, such as the address of the MRFP-A 224. This address may be a Uniform Resource Locator (URL) or other address designation. Other information in the response 306 message information may include a port identifier, transaction identifier, etc. This message information in the response 306 may be used to later identify the connection from the other endpoint(s).

According to normal IMS procedures for session-mode messaging, UE-A 200 then initiates 308A/308B the session creation towards the MRFC-A 220, which handles the session signaling for the conference/session service. In the session establishment messages, UE-A 200 indicates that MSRP is going to be used as the media. For example, a generic media description may take the form of:
m=<media><port><protocol><format list>
   where <media>has the value of “message”, and <protocol> represents at least the MSRP protocol and may also include a transport protocol. A representative example is shown below:
m=message 9999 msrp/tcp *
   The message body also includes the MRFP-A 224 address, which is delivered to UE-B 202 during session creation.

For purposes of this example, it is assumed that UE-B 202 has a local policy similar to that of UE-A 200, and must therefore also use an intermediary in its own network 206. UE-B 202 performs an MSRP “VISIT” operation to MRFP-B 226 in UE-B's home network 206, as depicted on message path 310. MRFP-B 226 will resolve the target address included in the VISIT request, and contact MRFP-A 224 via message path 312 to complete the establishment of the messaging relationship. MRFP-A 224 acknowledges the establishment with an MSRP “200 OK” message as shown on path 314 based on the address (e.g., URL) of MRFP-B 226, which is ultimately delivered to UE-B 202 as shown on path 316. At this point, the conference establishment is completed as shown at blocks 318A, 318B, and the UEs 200, 202 may engage in the messaging session 320 via the MRFP-A 224 and MRFP-B 226. Using the MSRP protocol, this may be accomplished using MSRP SEND primitives.

In this example, the MRFPs 224, 226 are seen as an endpoint to their respective UEs 200, 202. Therefore in one embodiment, the MRFPs terminate the messaging connection and copy incoming messages to all other participants in the conference. This works equally for two-way messaging conferences (e.g., with two endpoints) as well as for conferences involving more than two participants. Using such an implementation, point-to-point connections between all participants in a multi-party messaging session can be avoided, which can significantly reduce the number of required connections (e.g., Transport Control Protocol connections). In another embodiment, the MRFPs 224, 226 may also act as messaging relays, where they do not terminate the messaging connection, but rather relay the messages through. In such an embodiment, point-to-point connections are used between all conference participants.

While other network elements may serve the purpose of such an intermediary, the MRFPs 224, 226 represent one such network element that can serve as a relay/intermediary to which the principles of the present invention may be employed. In connection with the message flow described above, each of the UEs 200, 202 is subject to a local policy requiring the use of an intermediary, which is the respective MRFP 224, 226 in the illustrated example. Thus, the network introduces the intermediary (e.g., MRFP) into the messaging media path by way of local policy mandated by a proxy such as an S-CSCF. In accordance with one embodiment of the invention, such local policy is enforced by requiring confirmation that the UE has bound itself to the intermediary before allowing the creation, or alternatively the continuance, of a messaging session. Representative examples of manners to enforce such policy in accordance with the present invention are now described.

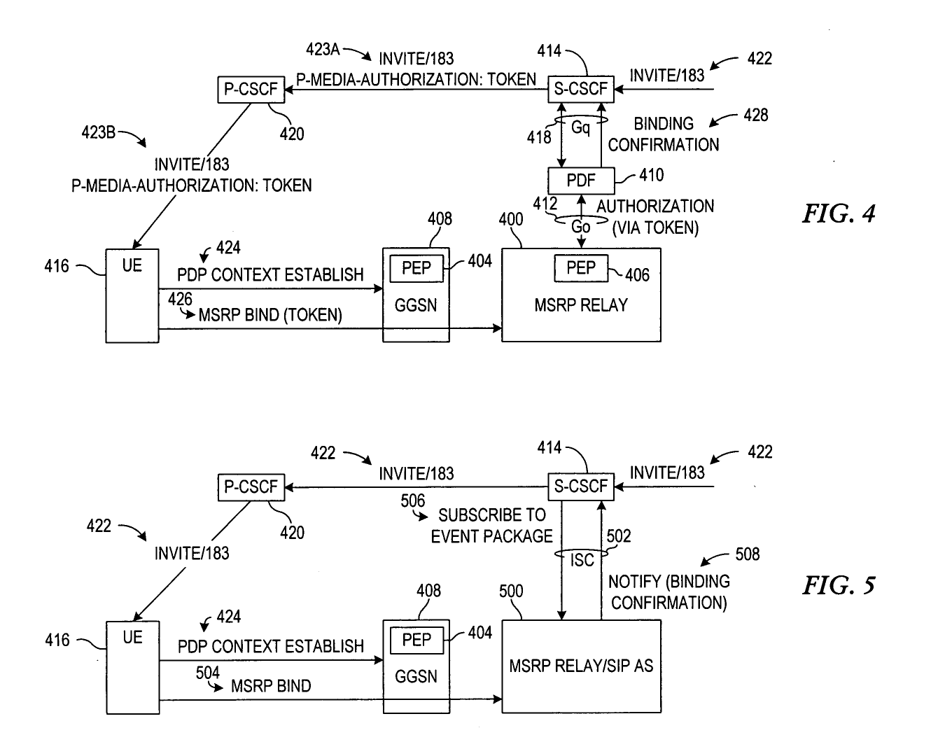

FIG. 4 is a block diagram illustrating a representative manner for providing signaling-level enforcement of local policies for bearer-level message sessions in accordance with one embodiment of the present invention. The embodiment of FIG. 4 is described in connection with IMS networks, where a “Go interface” is conventionally utilized between the GGSN and a Policy Decision Function (PDF) in order to allow the IMS network to control the network policies for media. The functional requirements of the Go interface are set forth in 3GPP TS 23.002: “Network architecture” and 3GPP TS 23.207: “End-to-end Quality of Service (QoS) concept and architecture”. The Go interface allows service-based local policy (SBLP) information to be pushed to or requested by a Policy Enforcement Point (PEP) in the GGSN from a PDF. As set forth in these specifications, this information may be used by the GGSN for functions such as GPRS bearer authorization, charging correlation, and policy-based gating functions in the GGSN.

In accordance with the embodiment of FIG. 4, the IMS SBLP infrastructure is extended in order to further include intermediaries, such as MSRP relays 400. In this embodiment, the Policy Enforcement Points (PEP) 404, 406 are located at the GGSN 408 and MSRP relay 400 respectively. The PEPs 404, 406 are logical entities that enforce policy decisions made by the PDF 410, where the PDF 410 is a logical policy decision element that uses standard Internet Protocol (IP) mechanisms to implement policy in the IP media layer. Conventionally, the PDF 410 makes decisions in regard to network-based IP policy using policy rules, and communicates these decisions to the PEP 404 in the GGSN 408. In accordance with the present invention, the PDF 410 communicates decisions to the PEP 406 in the MSRP relay 400 via the Go interface 412, which conventionally is only an interface between the GGSN 408 and a PDF 410.

This extended IMS SBLP infrastructure also includes associating the proxy element that applies local policy to the PDF 410. In the illustrated embodiment, the S-CSCF 414 represents the proxy at the signaling level that requires devices (e.g., UE 416) that are registered to the S-CSCF 414 to comply with the local policy. The S-CSCF 414 is coupled to the PDF 410 via a Gq interface 418. Conventionally, the Gq interface is an interface between a P-CSCF 420 and a PDF 410, as set forth in 3GPP TS 23.002, v6.3.0 (2003-12) entitled “Network Architecture,” Release 6 (hereinafter TS 23.002). As set forth in TS 23.002, the Gq interface allows for service-based policy set-up and Quality of Service (QoS) information to be exchanged between the PDF and the Application Function (AF), which is a P-CSCF in IMS networks. This information is used by the PDF for service based local policy decisions. The Gq interface is also known in the art via other specifications, such as TS 23.207, v6.1.1 (2004-01) entitled “End-to-end Quality of Service (QoS) concept and architecture,” Release 6, and TS 29.209, v0.0.1 (2003-08) entitled “Policy control over Gq interface,” Release 6. In accordance with embodiments of the present invention such as that presented in FIG. 4, the S-CSCF 414 is coupled to the PDF 410 via the Gq interface 418. As can be seen, the embodiment of FIG. 4 provides an extension to the existing IMS SBLP infrastructure to include MSRP relays such as MSRP relay 400, while using a Go interface 412 between the relay 400 and the PDF 410 and a Gq interface 418 between the PDF 410 and the S-CSCF 414.

In operation, the embodiment of FIG. 4 the S-CSCF 414 may receive a SIP INVITE 422, or other analogous signaling protocol invitation for communication, that is directed to UE 416. The S-CSCF 414 includes local policy indicating that the user of UE 416 must include the MSRP relay 400 (or other analogous intermediary) into the path of a message session with the initiating UE (not shown). When indicating to the UE 416 that the MSRP relay 400 shall be included into the signaling path, the S-CSCF 414 that applies this policy contacts the PDF 410 via the Gq interface 418.

In response, the PDF 410 generates a media authorization token which is ultimately transported via SIP signaling in, for example, a P-Media-Authorization header or other analogous message or message header field. More particularly, Media authorization tokens and the P-Media-Authorization header are described in the Internet Engineering Task Force (IETF) Request for Comments (RFC) 3313, entitled “Private Session Initiation Protocol (SIP) Extensions for Media Authorization,” January 2003 (hereinafter “RFC 3313”). Generally, RFC 3313 defines a private SIP header extension to support a media authorization scheme where the P-Media-Authorization general header field is defined. The media authorization tokens as specified in RFC 3313 are used for authorizing QoS for the media stream(s), where the P-Media-Authorization header field includes a media authorization token(s) that is to be included in subsequent resource reservations for the media flows associated with the session. The P-Media-Authorization header field may be described by:
P-Media-Authorization: P-Media-Authorization-Token

Returning to FIG. 4, the PDF 410 generates a P-Media-Authorization-Token or other media authorization token as defined by RFC 3313 or other analogous authorization token (hereinafter “token”). The token is returned to the S-CSCF 414 via the Gq interface 418, where it is forwarded to the P-CSCF 420. This is depicted by the updated INVITE 423A which includes a P-Media-Authorization header and associated token (P-Media-Authorization: Token). The P-CSCF 420 forwards the INVITE 423B and token to the targeted UE 416. Therefore, the token generated at the PDF 410 at the request of the S-CSCF 414 is ultimately provided via SIP signaling to the UE 416.

At this point the UE 416 has the token, and can establish a connection with the MSRP relay 400. First, a Packet Data Protocol (PDP) context 424 may be established in a conventional manner via the GGSN 408 in the case of GPRS network environments. For example, the UE 416 may perform GPRS attach procedures and establish the PDP context 424, which establishes the path to carry messages. More particularly, the UE 416 performs GPRS attach procedures as known in the art so that the location of the UE 416 is known to the network. Once attached, the UE 416 activates a PDP address that sets up an association between a Serving GPRS Support Node (SGSN; not shown) and the GGSN 408. Establishing a PDP context, which identifies the association between the SGSN and GGSN, activates an address for the UE 416 so that the UE 416 can communicate using that address.

Establishing the connection with the MSRP relay 400 further involves the UE 416 issuing a BIND primitive or message 426 to establish a session at a relay 400. When establishing the connection with the relay 400, the UE 416 includes the token into the BIND message 426. The MSRP relay 400 receives the token, and provides it to the PDF 410 via the Go interface 412. The PDF 410 determines whether the UE 416 is authorized to establish the connection, and if the authorization is successful, the PDF 410 notifies the MSRP relay 400 that the UE 416 is permitted to establish the connection.

The PDF 410 also indicates to the S-CSCF 414 that the UE 416 has appropriately bound the message session to the MSRP relay 400. This is depicted by the “binding confirmation” 428 which is provided to the S-CSCF 414 via the Gq interface 418 in the illustrated embodiment. In this manner, the network enforces the S-CSCF 414 local policy that the UE 416 must include the relay 400 into the message session path, by ensuring through the authorization process that the UE 416 has indeed bound the connection to the MSRP relay 400. Since a resulting message session will thus traverse the MSRP relay 400, functions such as per-message charging, logging, and/or other functions are therefore achievable.

It should be recognized that the embodiment of FIG. 4 is equally applicable to other signaling protocols, proxies, authorization methodologies, etc. Thus, reference to SIP in IMS networks, and to the particular P-Media-Authorization extension is described as a representative environment in which the present invention is applicable, although the invention is equally applicable in connection with analogous networks and protocols.

FIG. 5 is a block diagram illustrating a representative manner for providing signaling-level enforcement of local policies for bearer-level message sessions in accordance with another embodiment of the invention. The embodiment of FIG. 5 is again described in connection with IMS networks, and reference numbers corresponding to those used in FIG. 4 are used where appropriate. For example, the embodiment of FIG. 5 again includes an initial INVITE 422 (and/or session progress “183”), an S-CSCF 414, P-CSCF 420, UE 416, and GGSN 408.

In the embodiment of FIG. 5, no Go interface nor PDF is employed for the purpose of enforcing local policy, as was the case in the embodiment of FIG. 4. Rather, the embodiment of FIG. 5 represents an IMS Service Control (ISC)-based solution. ISC is described in the 3GPP IMS specification: TS 23.228, v6.4.1 (2004-01) entitled “IP Multimedia Subsystem (IMS),” Stage 2, Release 6. Particularly, ISC refers to the IMS service control interface which is a reference point between a CSCF and an Application Server (AS). An AS offers value-added IP Multimedia services, and may reside in the user's home network or in a third party location. In accordance with the embodiment of FIG. 5, the MSRP relay 500 also serves as a SIP Application Server (SIP AS), and is referred to herein as the relay/AS 500. The proxy that applies the policy (S-CSCF 414 in the illustrated embodiment) and the relay/AS 500 can then communicate via the SIP protocol, by way of the ISC interface 502.

In operation, the S-CSCF 414 may receive the SIP INVITE 422 that is targeted for the UE 416. The S-CSCF 414 includes local policy indicating that the user of UE 416 must include an intermediary, the MSRP relay 500 in the illustrated embodiment, into the path of a message session with the initiating UE (not shown). The INVITE 422 is sent from the S-CSCF 414 to the P-CSCF 420 and ultimately to the UE 416. At this point the UE 416 may establish a connection with the relay/AS 500. A PDP context 424 is established, and the UE 416 issues a standard MSRP BIND message 504 to the relay/AS 500, and the UE 416 thereby includes the MSRP relay 500 into the path of any session messages.

Meanwhile, the proxy applying the policies establishes a relationship with the relay/AS 500 that can be used to ultimately notify this proxy when the UE 416 has indeed performed the binding operation. More particularly, after (or otherwise substantially in connection with) instructing the UE 416 to include the relay 500 into the bearer path, the S-CSCF 414 subscribes 506 to a new event package at the relay/AS 500. Such a subscription may be accomplished using, for example, the SIP SUBSCRIBE method. By associating a SIP AS with the relay 500, the S-CSCF 414 can perform such a SIP subscription by subscribing to the SIP AS associated with the relay 500. The event to which the S-CSCF 414 (or analogous proxy applying local policy) is the inclusion of the MSRP relay 500 into the message path by the UE 416. When the subscribed event occurs, the relay/AS 500 can then notify 508 its subscriber—the S-CSCF 414 in this case—that the event has occurred and consequently that the required BIND has occurred. In other words, when the relay/AS 500 receives the BIND message 504 from the UE 416, the relay/AS 500 notifies 508 the S-CSCF 414 to provide a binding confirmation. The notification 508 may be provided to the subscriber using, for example, the SIP NOTIFY method.

As described in connection with FIG. 5, the state information provided by a notifier may be identified in advance, such that specific state information available to the notifier (relay/AS 500) is provided to the subscriber (S-CSCF 414). Alternatively, the S-CSCF 414 may subscribe to a new “event package” at the selected relay/AS 500, meaning the information provided by a notifier is provided by way of an event package that defines a set of state information to be reported by a notifier to a subscriber. More particularly, the S-CSCF 414 may subscribe to an event package for BIND confirmations at the relay/AS 500.

In the embodiments of FIGS. 4 and 5, the S-CSCF 414 controls the message session on the signaling level, based on whether a binding confirmation 428, 508 has been received at the S-CSCF 414. For example, if a binding confirmation 428, 508 is received by the S-CSCF 414 indicating proper UE 416 inclusion of the MSRP relay 400, 500 into the message session path, the S-CSCF 414 permits the UE 416 to engage in a message session with another participant(s) to the message session or conference. On the other hand, if a binding confirmation 428, 508 is not received, the S-CSCF 414 can release the session on the signaling level. In one embodiment, the S-CSCF 414 may delay forwarding any UE 416 message that the request was successful (e.g., 200 OK) to the initiating UE, unless and until the S-CSCF 414 has received the binding confirmation 428, 508. In another embodiment, the session may initially be allowed, but failure of receipt of the binding confirmation 428, 508 causes any initiated session to be released by the S-CSCF 414, such as by initiating a SIP BYE request. In either case, the S-CSCF 414 may release the message session if the user fails to include the relay 400, 500 as mandated by the local policy of the S-CSCF 414.

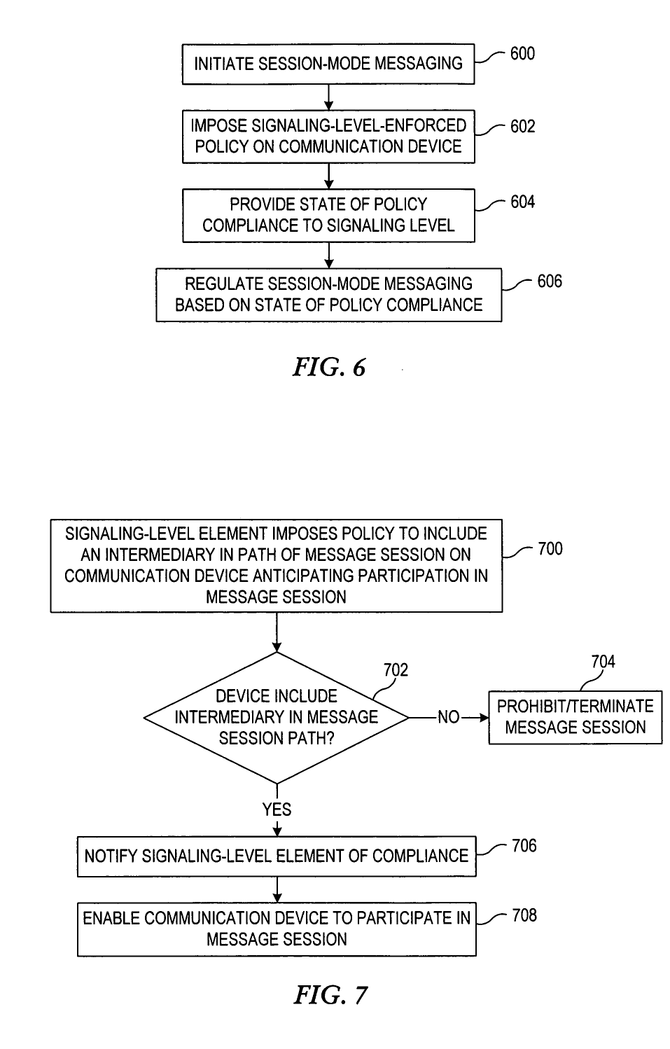

FIG. 6 is a flow diagram illustrating one embodiment of a method for enforcing a signaling-level policy on a message session that does not occur by way of the signaling plane. Session-mode messaging between two or more communication devices is initiated 600. For example, one communication device may send a SIP INVITE message towards one or more intended participants of the message session. At either or both ends of the message session, a policy is imposed 602 on the respective communication device by a signaling-level session control element. For example, an S-CSCF may impose a policy on the message session participant (e.g., mobile device) that is registered to that S-CSCF. In one embodiment, the policy requires that the message session participant establish a bearer-level “binding” between itself and a bearer-level relay. For example, S-CSCF policy may require a mobile device to send an MSRP BIND message to the MSRP relay that has been introduced into the infrastructure to facilitate the policy enforcement.

A state of this policy compliance (i.e. UE-relay binding) is determined and provided 604 to the signaling plane. For example, the MSRP relay will know whether the communication device has sent an MSRP BIND message to the MSRP relay, which in one embodiment serves as proof of the required binding, and therefore establishes a state of affirmative policy compliance. This information is ultimately provided to the signaling-level session control element (e.g., S-CSCF). Various manners in which this information is provided to the session control element are possible, such as in the representative embodiments of FIGS. 4 and 5. Based on this information, the S-CSCF or other session control element can regulate 606 whether the communication device can engage in the messaging session. For example, if the S-CSCF receives a binding confirmation indicating that the communication device has complied with the policy, the S-CSCF can allow the communication device to engage in the messaging session. Alternatively, if the S-CSCF does not receive a binding confirmation within a predetermined time, or receives a notification that the communication device has not complied with the policy, the S-CSCF can prohibit the communication device from engaging in the messaging session as previously described.

FIG. 7 is a flow diagram illustrating another embodiment of a method for enforcing signaling-level policies in accordance with the invention. A signaling-level element, such as an S-CSCF, imposes 700 a policy including a directive for the communication device to include an intermediary in the path of a message session. This policy is imposed upon the communication device(s) that is anticipating participation in the message session. For example, the S-CSCF can provide a SIP message or SIP response to the communication device to indicate that the communication device must send an MSRP BIND message to an MSRP relay, and thereafter communicate messages to the address of the MSRP relay when conducting the message session via MSRP. It is then determined 702 whether the communication device included the intermediary in the message session path. As previously indicated, this may be determined by an MSRP relay determining that the communication device has sent an MSRP BIND message to the MSRP relay. If this does not occur, the S-CSCF or other signaling-level element can prohibit/terminate 704 the message session. Otherwise, the MSRP relay can notify 706 the S-CSCF that the communication device has complied with the policy, whereby the S-CSCF enables 708 the communication device to participate in the message session.

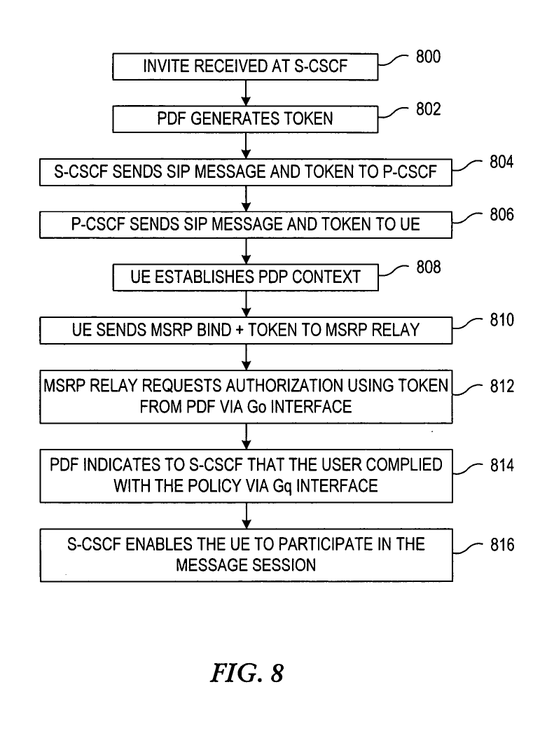

FIG. 8 is a flow diagram illustrating one embodiment of a method for enforcing such policies using a Go/Gq interface-based solution in an IMS network environment in accordance with the present invention. In the illustrated embodiment, the S-CSCF receives 800 a SIP INVITE message from a UE targeting a UE that has registered to the S-CSCF. The PDF generates 802 an authorization token at the request of the S-CSCF. The S-CSCF sends 804 the token via the SIP INVITE or response to the P-CSCF, which in turn sends 806 the message and token to the UE. The UE establishes 808 a PDP context and sends 810 an MSRP BIND, plus the token, to the MSRP relay. The MSRP relay requests 812 authorization, using the token, from the PDF via the Go interface. The PDF indicates 814 to the S-CSCF via the Gq interface that the user has complied with the policy by including the MSRP relay into the path of the message session. In response, the S-CSCF enables 816 the UE to participate in the message session.

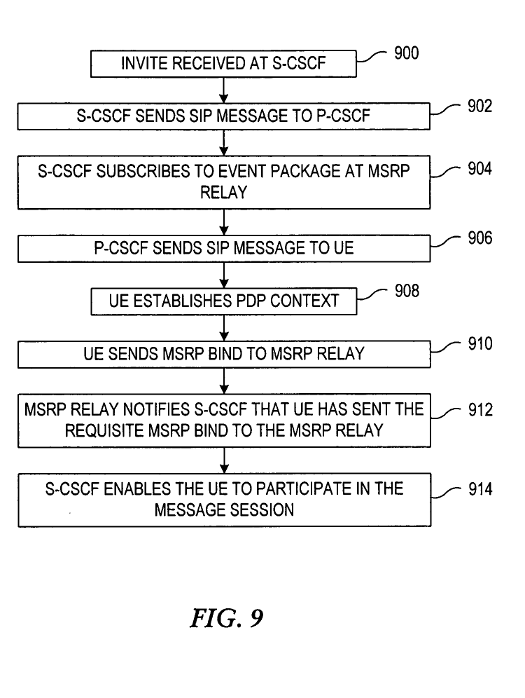

FIG. 9 is a flow diagram illustrating one embodiment of a method for enforcing such policies using an ISC-based solution in an IMS network environment in accordance with the present invention. In the illustrated embodiment, the S-CSCF receives 900 a SIP INVITE message from a UE targeting a UE that has registered to the S-CSCF. The S-CSCF sends 902 a SIP message to the P-CSCF, which in turn sends 906 the message and token to the UE. Meanwhile, the S-CSCF also subscribes 904 to an event package at the MSRP relay. The UE establishes 908 a PDP context and sends 910 an MSRP BIND to the MSRP relay. The MSRP relay notifies 912 the S-CSCF that the UE has sent the requisite MSRP BIND message to the MSRP relay to include the MSRP relay into the message path. Such a notification may be performed using, for example, the SIP NOTIFY method. In response, the S-CSCF enables 914 the UE to participate in the message session.

Using the description provided herein, the invention may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “computer-readable medium(s)” as used herein is intended to encompass a computer program that exists permanently or temporarily on such computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a system embodying the invention, and to create a system for carrying out the methods of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather defined by the claims appended hereto.

1. A method for enforcing a signaling-level policy on bearer-level session-mode messaging, comprising:
initiating session-mode messaging involving a first communication device and one or more second communication devices;
imposing a policy by a signaling-level session control element on at least the first communication device to establish a bearer-level binding between the first communication device and bearer-level relay;
determining a state of the bearer-level binding, and providing the state of the bearer-level binding to the signaling-level session control element; and
at the signaling-level session control element, allowing or disallowing the session-mode messaging based on the state of the bearer-level binding.

2. The method of claim 1, wherein imposing a policy comprises requiring the first communication device to include the bearer-level relay in a path of the session-mode messaging between the first communication device and the one or more second communication devices.

3. The method of claim 2, wherein the session-mode messaging is conducted using a Message Session Relay Protocol (MSRP) and the bearer-level relay comprises an MSRP relay, and further comprising the first communication device issuing an MSRP BIND message to the MSRP relay to establish the bearer-level binding between the first communication device and the MSRP relay.

4. The method of claim 3, further comprising updating the state of the bearer-level binding to indicate a binding confirmation if the MSRP relay receives the MSRP BIND message from the first communication device, wherein allowing or disallowing the session-mode messaging comprises the signaling-level session control element allowing the session-mode messaging where the state of the bearer-level binding indicates the binding confirmation.

5. The method of claim 4, wherein:
determining a state of the bearer-level binding comprises determining whether the state of the bearer-level binding has been updated to indicate a binding confirmation in response to the MSRP relay receiving the MSRP BIND message within a predetermined time; and
allowing or disallowing the session-mode messaging comprises the signaling-level session control element disallowing the session-mode messaging where the state of the bearer-level binding has not been updated to indicate the binding confirmation within the predetermined time.

6. A method for enforcing signaling-level policies directed to bearer-level message sessions, comprising:
imposing at least one policy on a communication device anticipating participation in a message session, wherein the policy is initiated at a signaling-level element and includes a directive for the communication device to include an intermediary in a path of the message session;
determining whether the communication device has included the intermediary in the path of the message session;
notifying the signaling-level element if it is determined that the communication device has included the intermediary in the path of the message session; and
enabling the communication device to participate in the message session in response to the signaling-level element receiving the notification.

7. The method of claim 6, further comprising disallowing the communication device to participate in the message session if it is determined that the communication device has not included the intermediary in the path of the message session.

8. The method of claim 7, wherein determining whether the communication device has included the intermediary in the path of the message session comprises determining whether the signaling-level element receives the notification within a predetermined time.

9. The method of claim 6, wherein determining whether the communication device has included the intermediary in the path of the message session comprises determining whether the intermediary has received from the communication device a binding message identifying the intermediary.

10. The method of claim 6, further comprising the communication device including the intermediary into the path of the message session by issuing a binding message to the intermediary to establish the intermediary as a portion of the path of the message session.

11. The method of claim 10, wherein the message session is conducted using a Message Session Relay Protocol (MSRP) and the intermediary comprises an MSRP relay, and wherein issuing a binding message to the intermediary comprises issuing an MSRP BIND message from the communication device to the MSRP relay.

12. The method of claim 6, wherein imposing at least one policy that is initiated at a signaling-level element comprises imposing the policy via a Serving-Call Session Control Function (S-CSCF) within an Internet Protocol (IP) Multimedia Subsystem (IMS).

13. The method of claim 12, wherein imposing the policy via an S-CSCF within an IMS comprises sending the policy from the S-CSCF to the communication device via Session Initiation Protocol (SIP) signaling.

14. The method of claim 6, wherein the message session is conducted using a Message Session Relay Protocol (MSRP) and the intermediary comprises an MSRP relay.

15. The method of claim 14, further comprising sending an MSRP BIND message from the communication device to the MSRP relay to include the MSRP relay in the path of the message session.

16. The method of claim 14, wherein the signaling-level element comprises a Serving-Call Session Control Function (S-CSCF) within an Internet Protocol (IP) Multimedia Subsystem (IMS), and wherein imposing at least one policy that is initiated at a signaling-level element comprises:
the S-CSCF requesting generation of an authorization token from a Policy Decision Function (PDF);
transmitting the authorization token to the communication device; and
requesting the communication device to send the MSRP BIND message, including the authorization token, to the MSRP relay.

17. The method of claim 16, wherein determining whether the communication device has included the intermediary in the path of the message session comprises:
sending at least the authorization token from the MSRP relay to the PDF via a Go interface; and
determining at the PDF that the communication device is authorized to participate in the message session based on receipt of the authorization token.

18. The method of claim 17, wherein notifying the signaling-level element comprises notifying the S-CSCF by the PDF that the communication device has included the MSRP relay in the path of the message session and is authorized to participate in the message session.

19. The method of claim 18, wherein notifying the S-CSCF by the PDF comprises notifying the S-CSCF via a Gq interface between the S-CSCF and the PDF.

20. The method of claim 14, wherein the signaling-level element comprises a Serving-Call Session Control Function (S-CSCF) within an Internet Protocol (IP) Multimedia Subsystem (IMS), and wherein the MSRP relay comprises an Application Server (AS).

21. The method of claim 20, further comprising the S-CSCF subscribing to one or more events at the AS, and wherein notifying the signaling-level element comprises providing a notification message from the AS to the S-CSCF if it is determined that the communication device has included the intermediary in the path of the message session.

22. The method of claim 21, wherein providing a notification message from the AS to the S-CSCF comprises providing a SIP NOTIFY message via an IMS Service Control (ISC) interface.

23. A method for enforcing signaling-level policies directed to bearer-level message sessions, comprising:
initiating at least one policy at a signaling level;
imposing the policy on a communication device anticipating involvement in a message session;
determining at the bearer level whether the communication device has complied with the policy;
notifying the signaling level if it is determined at the bearer level that the communication device has complied with the policy; and
allowing the communication device to engage in the message session in response to receipt of the notification of policy compliance at the signaling level.

24. The method of claim 23, wherein initiating at least one policy at a signaling level comprises initiating a policy requiring the communication device to include an intermediary in a bearer-level path of the message session.

25. A system for enforcing signaling-level policies in an IP Multimedia Subsystem (IMS) network, comprising:
a first communication device capable of communicating signaling messages via the IMS network and participating in session-mode messaging via a bearer path;
a signaling-level proxy configured to impose at least one policy on the first communication device via the IMS network; wherein the policy requires the first communication device to include the intermediary into the bearer path of the session-mode messaging;
an intermediary configured to relay messages of the session-mode messaging between the communication device and one or more second communication devices, wherein the intermediary is configured to receive at least one binding message from the first communication device, and in response to provide compliance information indicating compliance of the policy by the first communication device; and
wherein the signaling-level proxy is configured to enable the session-mode messaging in response to the compliance information.

26. The system as in claim 25, wherein:
the signaling-level proxy comprises a Serving-Call Session Control Function (S-CSCF);
the session-mode messaging is conducted using a Message Session Relay Protocol (MSRP) via the bearer path; and
the intermediary comprises an MSRP relay.

27. The system as in claim 26, wherein the MSRP relay comprises an Multimedia Resource Function Processor (MRFP).

28. The system as in claim 26, wherein the first communication device comprises a processor configured to generate the binding message as an MSRP BIND message for transmission to the MSRP relay to include the MSRP relay into the bearer path for the session-mode messaging.

29. The system as in claim 28, further comprising a Policy Decision Function (PDF) logically coupled between the MSRP relay and the S-CSCF, wherein the MSRP relay is configured to forward an authorization token received via the MSRP BIND message to the PDF, and wherein the PDF is configured to provide the compliance information to the S-CSCF in response to receiving the authorization token.

30. The system as in claim 29, further comprising a Go interface between the MSRP relay and the PDF to communicate at least the authorization token.

31. The system as in claim 29, further comprising a Gq interface between the PDF and the S-CSCF to communicate at least the compliance information.

32. The system as in claim 28, wherein the MSRP relay comprises an Application Server (AS), and wherein the S-CSCF is configured to subscribe to an event package at the AS for notifications regarding the compliance information.

33. The system as in claim 32, wherein the AS is configured to issue a notification to the subscribing S-CSCF via an IMS Service Control (ISC) interface in response to the MSRP relay receiving the MSRP BIND message.

34. The system as in claim 33, wherein the AS comprises a Session Initiation Protocol (SIP) AS, and wherein:
the S-CSCF is configured to subscribe to the event package using a SIP SUBSCRIBE method; and
the SIP AS is configured to issue the notification to the subscribing S-CSCF using a SIP NOTIFY method.

35. One or more computer-readable mediums having instructions stored thereon that are executable by computing systems for enforcing a signaling-level policy on bearer-level session-mode messaging by performing steps comprising:
imposing a policy by a signaling-level session control element on at least a first communication device to establish a bearer-level binding between the first communication device and bearer-level relay;
determining a state of the bearer-level binding between the first communication device and the bearer-level relay; and
allowing or disallowing the first communication device to engage in a message session based on the state of the bearer-level binding.
